(19) United States
(12) Patent Application Publication
(10) Pub. No.: US 2026/0141286 A1
(43) Pub. Date: May 21, 2026

(54) ADAPTIVE HYPERDIMENSIONAL COMPUTING FOR NOISE-RESILIENT ON-DEVICE TIME SERIES FORECASTING

(71) Applicant: The Regents of the University of California, Oakland, CA (US)

(72) Inventors: Ivannia Gomez Moreno, La Jolla, CA (US); Xiaofan Yu, San Diego, CA (US); Tajana Simunic Rosing, San Diego, CA (US)

(21) Appl. No.: 18/950,577

(22) Filed: Nov. 18, 2024

(51) Int. Cl. G06N 20/00

(52) U.S. Cl. CPC G06N 20/00

(57) ABSTRACT

Some inventive concepts described herein relate to an Adaptive Hyperdimensional Forecasting System that provides a robust and lightweight solution for on-device time series forecasting by integrating Hyperdimensional Computing with a Kalman Filter. The system can combine the resilience of the Kalman Filter to sensor noise with the computational efficiency of HDC, making it highly suitable for edge deployment. The system can encode historical data into high-dimensional hypervectors and apply an iterative Kalman-based process to estimate and update forecasting weights. Efficient binary operations can be used to enhance computational performance, reducing complexity compared to conventional methods. This configuration may support noise-resilient forecasting on edge devices with limited computational, storage, and energy resources, delivering efficient and accurate forecasts suitable for real-time applications in resource-constrained environments.

### STATEMENT OF GOVERNMENT SUPPORT

The inventive concepts described herein were made with government support, partially funded by the National Science Foundation, under Grants #2003279, #1826967, #2100237, #2112167, #1911095, and #2112665, and by the Semiconductor Research Corporation (SRC) under task #3021.001. The inventive concepts were also partially supported by PRISM and CoCoSys, which are centers within the JUMP 2.0 program, an initiative of the SRC funded by the Defense Advanced Research Projects Agency (DARPA). The federal government retains certain rights in this invention.

### FIELD

The present disclosure generally relates to data-driven predictive modeling and machine learning, and, more particularly, to adaptive computational techniques for improving efficiency and robustness in predictive modeling.

### BACKGROUND

Time series forecasting can be applied in a wide range of areas, including energy management, transportation systems, and industrial monitoring. In these contexts, forecasting models can predict future values based on historical data, providing opportunities for proactive decision-making and optimization of resources. Forecasting can enhance efficiency and sustainability, particularly in systems that function under real-time conditions.

Traditional approaches to time series forecasting can include statistical models, such as Autoregressive Integrated Moving Average (ARIMA), and neural network-based techniques. Statistical models are well-established and can be suitable for handling small datasets, though they may encounter challenges when capturing complex temporal dependencies in large-scale or non-linear time series. Neural networks, including Long Short-Term Memory (LSTM) networks, can be effective in capturing such relationships but may have limitations when applied in real-time due to their computational complexity and resource requirements.

In many forecasting applications, data can be collected from multiple sensors operating in environments where noise and disturbances are present, such as Gaussian noise, missing values, and other types of irregularities. Such noise can affect the performance of forecasting models and lead to less accurate predictions. While neural network models can be adapted to handle these noisy conditions, this often involves advanced architectures requiring substantial computational power and large datasets to achieve robustness. As a result, these models can be challenging to implement on edge devices, which are typically resource-constrained.

Edge computing can provide advantages for performing real-time data processing near the data source, thereby potentially reducing latency and saving communication costs. However, edge devices generally have limited resources, including memory, computational power, and energy. This context can create challenges for deploying complex forecasting models directly on edge devices. The ability to achieve accurate and timely forecasts on such resource-constrained devices can depend on the development of approaches that balance computational efficiency with robustness against noisy input data.

Hyperdimensional Computing (HDC) has been explored for its potential to efficiently process data through lightweight, highly parallelizable operations. Inspired by brain-like computing, HDC involves mapping data into high-dimensional vectors, or hypervectors, which can simplify the representation and processing of complex data. HDC has been applied to areas such as classification and pattern recognition. However, existing HDC-based methods for time series forecasting, such as RegHD, may face limitations in the presence of noisy sensor data and may require multiple passes through the data for training, which can reduce their effectiveness in real-time or streaming contexts.

### SUMMARY

Certain illustrative examples are described in the following numbered clauses:

Clause 1. A method for on-device time series forecasting using Hyperdimensional Computing and a Kalman Filter, comprising:
encoding, using Hyperdimensional Computing, a data sample of one or more historical time series values from at least one sensor into a high-dimensional hypervector, wherein the encoding comprises applying a transformation to generate the high-dimensional hypervector;
training a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
performing inference by generating a predicted value through a computation between the high-dimensional hypervector and the forecasting weight hypervector,
wherein the encoding and inference operations are performed in a single pass for the data sample.

Clause 2. The method of clause 1, wherein each data sample is processed only once during the training and inference operations, without requiring multiple epochs, iterative revisits, or reprocessing.

Clause 3. The method of clause 1, further comprising outputting an indication of the predicted value, wherein the predicted value is a forecasted future value of the time series data.

Clause 4. The method of clause 1, wherein the Kalman Filter employs no matrix multiplications for updating the covariance representation and calculating the Kalman Gain.

Clause 5. The method of clause 1, wherein the Kalman Filter employs only binary operations for updating the covariance representation and calculating the Kalman Gain.

Clause 6. The method of clause 1, wherein updating the forecasting weight hypervector further comprises updating the covariance matrix using the Kalman Gain, wherein the Kalman Gain is computed based on the high-dimensional hypervector and applied to adjust the covariance matrix.

Clause 7. The method of claim 1, wherein encoding comprises transforming the historical time series values into the high-dimensional hypervector using a random projection followed by a non-linear transformation.

Clause 8. The method of claim 1, wherein encoding comprises processing time series data from multiple sensors, with sensor data from each sensor being encoded separately, and wherein a unified forecasting weight hypervector is used to generate the predictions.

Clause 9. The method of claim 1, wherein training the forecasting weight hypervector comprises iteratively adjusting the forecasting weight hypervector using discrepancies between predicted values and actual values, and wherein estimating the forecasting weight hypervector comprises calculating a Kalman Gain based on a covariance matrix and received data sample.

Clause 10. The method of claim 6, wherein the covariance matrix is calculated in a hyperdimensional space.

Clause 11. The method of claim 1, further comprising updating the forecasting weight hypervector based on a determination that a prediction error satisfies a predefined threshold.

Clause 12. The method of claim 1, wherein the Kalman Filter estimates a forecasting weight hypervector for each of multiple sensors, wherein each high-dimensional hypervector corresponds to historical data received from a respective sensor.

Clause 13. The method of claim 1, further comprising determining a variance of the received data samples, wherein the variance is used by the Kalman Filter to adjust the iterative updating of the forecasting weight hypervector.

Clause 14. The method of clause 1, further comprising determining a variance for the received data sample, wherein the variance is calculated based on previous and current data samples, and is iteratively updated as each new data sample is received.

Clause 15. An edge device for on-device time series forecasting, comprising:
a processor configured to:
encode, using Hyperdimensional Computing, a data sample of one or more historical time series values from at least one sensor into a high-dimensional hypervector, wherein the encoding comprises applying a transformation to generate the high-dimensional hypervector;
train a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
perform inference by generating a predicted value through a computation between the high-dimensional hypervector and the forecasting weight hypervector,
wherein the encoding and inference operations are performed in a single pass for the data sample.

Clause 16. The device of claim 17, further comprising the at least one sensor configured to collect the time series data, and a memory configured to store the forecasting weight hypervector, the high-dimensional hypervector, and intermediate results for encoding, training, and inference.

Clause 17. A non-transitory computer-readable medium storing instructions that, when executed by a processor, cause the processor to perform a method for on-device time series forecasting using Hyperdimensional Computing (HDC) and a Kalman Filter, the method comprising:
encoding, using Hyperdimensional Computing, a data sample of one or more historical time series values from at least one sensor into a high-dimensional hypervector, wherein the encoding comprises applying a transformation to generate the high-dimensional hypervector;
training a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
performing inference by generating a predicted value through a computation between the high-dimensional hypervector and the forecasting weight hypervector,
wherein the encoding and inference operations are performed in a single pass for the data sample.

Clause 18. The non-transitory computer-readable medium of clause 17, wherein each data sample is processed only once during the training and inference operations, without requiring multiple epochs, iterative revisits, or reprocessing.

Clause 19. The non-transitory computer-readable medium of clause 17, wherein the Kalman Filter employs only binary operations for updating the covariance representation and calculating the Kalman Gain.

Clause 20. The non-transitory computer-readable medium of clause 17, wherein the Kalman Filter employs no matrix multiplications for updating the covariance representation and calculating the Kalman Gain.

### BRIEF DESCRIPTION OF THE DRAWINGS

FIG. 1 illustrates an example of a Kalman Filter (KF) process used for time series forecasting, showing the prediction, innovation, and updating phases.

FIG. 2 illustrates the framework of an example Adaptive Hyperdimensional Forecasting System, including encoding, inference, and training phases, for on-device time series forecasting.

FIG. 3 presents two plots illustrating the average mean absolute error (MAE) for different methods when applied to datasets with various rates of missing samples.

FIG. 4 presents two plots illustrating the average MAE for all forecasting methods under varying levels of Gaussian noise, comparing different forecasting methods.

FIG. 5 presents two plots that show the average MAE of the different forecasting methods under varying levels of Poisson noise, comparing the disclosed Adaptive Hyperdimensional Forecasting System with other models.

FIG. 6 presents two bar charts illustrating the average execution times, in seconds, of each baseline model and the Adaptive Hyperdimensional Forecasting System for completing a single pass on traffic and energy datasets.

FIG. 7 presents a flow diagram illustrating an embodiment of an on-device time series forecasting routine that can be implemented by the Adaptive Hyperdimensional Forecasting System on edge devices.

### DETAILED DESCRIPTION

Forecasting time series data in edge computing environments can be highly beneficial for modern Internet of Things (IoT) applications, helping devices make timely, data-driven decisions. Traditional methods for forecasting, such as statistical models or neural networks, can face limitations when applied to edge devices, which often have restricted processing power and need to handle noisy data. These challenges can indicate the need for a more adaptable and efficient forecasting system that works well in such environments while managing resource constraints.

Some inventive concepts described herein relate to an Adaptive Hyperdimensional Forecasting System that can improve time series forecasting for edge computing. The Adaptive Hyperdimensional Forecasting System can be configured to process data collected from multiple sensors while addressing different types of common sensor noise, such as Gaussian noise, missing values, and Poisson noise. The Adaptive Hyperdimensional Forecasting System can integrate aspects of HDC with Kalman Filters (KF), leveraging their combined strengths to enable predictions that are resilient to sensor noise. The Adaptive Hyperdimensional Forecasting System can maintain an efficient, single-pass training process that operates effectively for edge computing, preserving the lightweight properties associated with HDC. For example, the Adaptive Hyperdimensional Forecasting System can encode time series data into high-dimensional vectors and iteratively update forecasting weights using an Expectation-Maximization (EM) approach, which can help improve prediction accuracy. In some cases, the KF component can be used to estimate unknown state variables from observations under the assumption of Gaussian noise.

Some inventive concepts described herein relate to the technical challenges involved in the design of the Adaptive Hyperdimensional Forecasting System. One challenge can include determining which elements of the forecasting process should operate within hyperdimensional space and which should remain in the original dimensional representation. Another challenge can involve adapting these operations for effective use within hyperdimensional space while ensuring that the original function of the KF is maintained. To address these or other challenges, the Adaptive Hyperdimensional Forecasting System can incrementally incorporate elements of HDC into the KF base to ensure that the learning process remains intact. Specifically, the Adaptive Hyperdimensional Forecasting System can use an EM algorithm to train a forecasting weight hypervector, which, when multiplied by hypervectors encoded from raw time series data, produces a forecast for the subsequent time step.

Some inventive concepts described herein relate to simplifying the computational approach for forecasting in edge environments. The Adaptive Hyperdimensional Forecasting System can use binary operations as an approximation for matrix multiplications, which are typically required in KFs. This approximation can contribute to a reduction in computational complexity, making the Adaptive Hyperdimensional Forecasting System more suitable for environments where processing power and energy are limited. By simplifying these operations, the Adaptive Hyperdimensional Forecasting System can retain robust forecasting capabilities without compromising resilience to sensor noise, thereby maintaining efficiency.

Some inventive concepts described herein relate to the evaluation of the Adaptive Hyperdimensional Forecasting System across multiple real-world IoT scenarios, such as monitoring traffic and electrical consumption. Evaluations can demonstrate that the Adaptive Hyperdimensional Forecasting System provides improved prediction accuracy in noisy environments, surpassing existing HDC-based baselines by up to 72%. Furthermore, the Adaptive Hyperdimensional Forecasting System can achieve notable efficiency gains, demonstrating execution times that are 3.6 to 8.6 times faster than conventional neural-network methods, thereby supporting real-time operation in edge computing contexts.

Some inventive concepts described herein relate to how the Adaptive Hyperdimensional Forecasting System can adaptively manage training when handling noisy data. For instance, the Adaptive Hyperdimensional Forecasting System can selectively update forecasting weights only when the observed prediction error surpasses a predefined threshold. This targeted updating approach can help avoid unnecessary computational activity, contributing to the overall efficiency of the Adaptive Hyperdimensional Forecasting System and conserving resources, which can be particularly beneficial for edge devices with constrained capabilities.

Some inventive concepts described herein relate to improving on-device forecasting by combining HDC with KFs and incorporating adaptive methods for training and reducing computational demands. By leveraging these combined approaches, the Adaptive Hyperdimensional Forecasting System can offer a lightweight and robust solution for predicting time series data in resource-constrained environments. These inventive concepts can help provide reliable, noise-resilient forecasting while managing computational and energy resources effectively. This advancement can facilitate better use of forecasting technologies in various IoT applications, supporting scalability in environments that require real-time data analysis and decision-making.

### I. Introduction

The widespread applications of the Internet of Things (IoT) in healthcare, transportation, and smart cities highlight the importance of IoT in modern society. Sensor time series data, where observations are recorded sequentially over time, can play a significant role in applications involving IoT. Time series forecasting can gain increased attention in IoT research. Forecasting involves predicting future values based on historical data, providing valuable insights across different domains and facilitating resource conservation. Consequently, timely decision-making at the source of IoT data can become advantageous. In contrast to cloud computing, edge computing can bring data processing and analysis closer to the data source. Edge computing can allow real-time training and inference to be performed on edge devices. Forecasting models can increasingly adopt edge computing to enable timely decision-making, save communication costs, and support operations in remote areas, thereby enhancing scalability.

Edge devices can possess limited computational, storage, and energy resources, which can make accurate forecasting challenging. Additionally, time series data streams can often be affected by noise, such as Gaussian noise simulating sensor disruptions, missing samples due to power issues, or Poisson noise caused by electrical disturbances. These noise factors can pose significant challenges, potentially reducing forecasting accuracy and affecting overall performance. Forecasting models can leverage information from multiple edge sensors, as well as efficiently use on-board resources to address these limitations.

Early research indicates that statistical models, such as BHT-ARIMA, and linear approaches, such as support vector regression and random forest, can perform well with limited data. Recently, Neural Networks (NN) and deep learning models, such as recurrent neural networks (RNN) and long-short-term memory (LSTM), have emerged as popular approaches for forecasting problems due to the adaptability and robustness to noise offered by these models. However, these approaches often require multiple iterations (epochs) of the complete data stream to capture relationships between previous values, which may not be suitable for edge settings where streaming data is involved. Additionally, NN-based methods can require a large volume of data samples and can exhibit a resource-intensive and slow training process.

HDC is an emerging computing paradigm that aims to mimic the functioning of the human brain. HDC involves mapping input values to high-dimensional sparse vectors, which are referred to as hypervectors. Training can be performed on hypervectors with well-defined and highly parallelizable operations. These characteristics can make HDC lightweight to train, robust against hardware errors, and conducive to single-pass training under limited observations. All of these benefits align with the challenges that can accompany edge forecasting applications. While the vast majority of HDC research has focused on classification problems, RegHD is a regression algorithm developed within the HDC domain. RegHD encodes time series data into a binary hypervector, which can be used to forecast the next value. The encoding and forecasting operations are relatively simple, thereby reducing computational costs. However, RegHD often requires multiple epochs to converge and can be susceptible to sensor noise, which can make this approach less suitable for edge scenarios.

### A. Time Series Forecasting

Time series forecasting can be important for monitoring edge scenarios and making local decisions, such as decisions related to energy usage and conservation. Initial approaches, such as Autoregressive Integrated Moving Average (ARIMA), have been widely used for their statistical properties and versatility. ARIMA combines autoregression (AR) and moving average (MA) to model relationships between past and future values. However, ARIMA may incur high computational costs and may not effectively capture relationships among correlated time series. Adaptations, such as SARIMA and ARIMAX, have emerged to capture non-linearities in time series data, but long-term predictions can remain challenging.

An alternative forecasting approach for large panels of related time series can involve neural networks (NN). Neural networks can be used to simultaneously forecast multiple time series, capturing longer-term relationships within the data. Different neural network architectures, such as Multi-Layer Perceptrons (MLPs), Convolutional Neural Networks (CNNs), Long Short-Term Memory networks (LSTMs), and other NN-based methods have been applied in this domain. However, neural networks can face challenges related to training complexity and practical applicability.

Despite the potential advantages of neural networks, the majority of these methods focus on cloud-based computing without considering memory or energy constraints. Few studies have addressed the issue of time series forecasting on the edge. Furthermore, noise present in edge devices is often disregarded or managed using deep networks, which can add computational complexity.

### B. Robust Forecasting

Recent research has focused on developing robust neural network models to handle Gaussian noise and missing values in time series data. The E-Sense approach utilizes a Mixture of Experts technique, combining multiple layers of a Convolutional Neural Network (CNN) and a parallel Long Short-Term Memory (LSTM) model to address various types of noise, including Gaussian noise. Another relevant approach is PFVAE, which employs an LSTM as an auto-encoder and a variational auto-encoder (VAE) for time series prediction to mitigate the effects of Gaussian noise. However, achieving a robust level of performance often requires substantial training data and computational resources.

### C. HDC

Compared to neural networks, HDC can provide superior energy efficiency and a faster learning rate, as demonstrated by multiple classification algorithms such as TempHD, drive style classification, and SemiHD. HDC methods have been explored in a variety of applications. It is noteworthy that HDC may not be inherently robust against noise in the original data space, which can impact performance in IoT scenarios. RegHD represents an approach that combines regression algorithms with HDC to transform models into a hypervector representation, suitable for managing IoT data with hardware noise. However, the RegHD method often requires multiple passes through training data, which may make it better suited for offline training rather than online training.

### HDC and KFS

### A. HDC Primitives

HDC is inspired by the neuroscience community, seeking to emulate human brain functioning. HDC maps raw signal values into high-dimensional vectors, known as hypervectors, which often consist of tens of thousands of dimensions. In general, the fundamental idea behind HDC is that intricate patterns within the original space can potentially be linearly separable when projected into a sparse, high-dimensional space. The following describes three typical steps in HDC.

Encoding: Encoding can be an initial step to map raw data into hypervectors. In the Adaptive Hyperdimensional Forecasting System, Random Projection can be used, followed by non-linear operations for encoding. This approach can be effective for achieving high performance in time series analysis, providing an efficient means of transforming input data into a suitable format for subsequent processing stages. Let the raw values to be encoded be represented as X∈ [symbol] ^{p}. Random Projection is then applied to the input data, where each value is element-wise multiplied by a random hypervector h∈ [symbol] ^{d}. Each hᵢ is chosen from N (0,1), followed by an L2 normalization. The result of this process is a set of d-dimensional hypervectors, which are added together to create a single hypervector hv. Subsequently, a non-linear encoding can be applied as cos (hν+b)·sin (hν), where the bias b is chosen from U (0, 2π). he hypervector can be projected into a bipolar form, where each element is from {−1,1}, using the sign function. Mathematically, the complete encoding process can be expressed as follows:

$$hv = {\sum }_{i}^{p} {X}_{i} \cdot {h}_{i} , hv = \frac{hv}{max ( {‖ hv ‖}_{2} , \text{?} )} \qquad ( 1 )$$

$$hv = cos ( hv + b ) \cdot sin ( hv ) \qquad ( 2 )$$

$$ϕ ( X ) = sign ( hv ) \qquad ( 3 )$$

$$\text{?} \text{indicates text missing or illegible when filed}$$

Training: During the training phase, representative hypervectors are created for each class. By adding the samples that belong to the same class together, a hypervector closely related to all the samples in that class is formed. Given the hypervectors X^{j} represent the samples from class j, the class hypervectors are computed

$$ϕ ( {c}_{j} ) = {⊕}_{i} ϕ ( {X}_{i}^{j} ) .$$

Inference: During inference, similarities between the query input X_{q} and all the class hypervectors are calculated. The sample is then assigned to the class with the highest similarity score ŷ, i.e., ŷ=argmaxⱼ cos (φ(X_{q}), φ(cⱼ)).

### B. KFs

An effective single-pass approach, designed for a limited number of samples and noise, is KF. The objective of KF is to ascertain a hidden state through observations governed by the underlying system. For IoT time series forecasting, the past samples Hₜ are known, while the coefficients (hidden state αₜ) required to predict the future values based on these samples remain unknown. The accuracy of these coefficients can only be verified once the real next step is obtained, which serves as the observed state. KF utilizes the EM (Expectation-Maximization) algorithm, which iteratively refines the model to approximate the true hidden state until convergence, guided by the observed state.

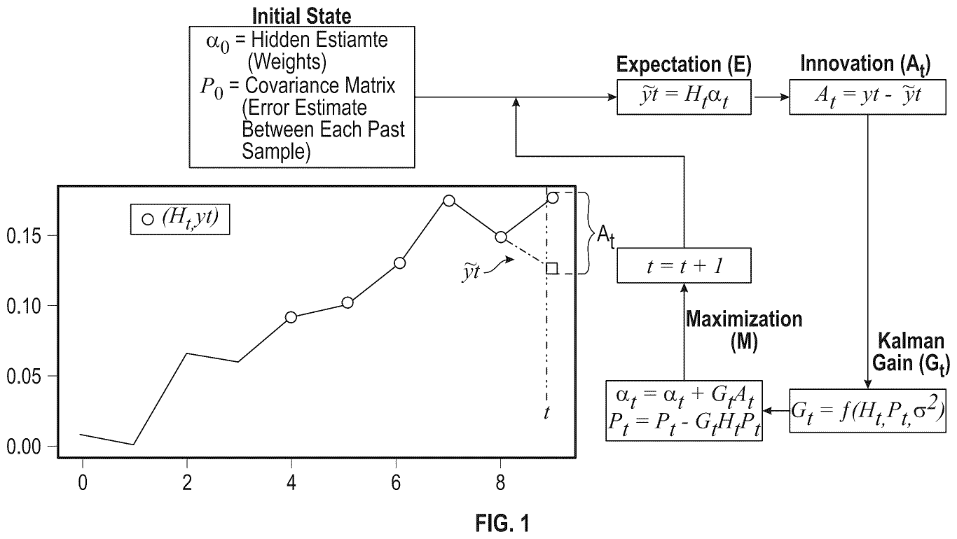

FIG. 1 illustrates an example of a Kalman Filter (KF) process used for time series forecasting, showing the prediction, innovation, and updating phases. As illustrated in FIG. 1, KF begins with randomly initialized weights denoted as α₀∈ [symbol] ^{p}, forming the vector of coefficients necessary for forecasting. Additionally, a covariance matrix P₀ is created to represent the relationships between these weights. At each timestamp t, the algorithm performs the E step, computing a prediction using the current weights y̅ₜ=Hₜαₜ. This prediction estimates the next value in the time series, as observed by the dotted line in the bottom left corner of FIG. 1. The innovation term (Aₜ) signifies the difference between the predicted value and the actual future value (yₜ−\tilde{y}ₜ).

Next, the Kalman Gain Gₜ is computed using the formula:

$$f ( {H}_{t} , {P}_{t} , {σ}^{2} ) = \frac{{P}_{t} {H}_{t}^{T}}{{H}_{t} {P}_{t} {H}_{t}^{T} + {σ}^{2}} .$$

This calculation involves the previous samples Hₜ, the covariance matrix Pₜ, and the variance of the data σ². The covariance matrix captures the uncertainty or variance in the estimates of the hidden state variables and represents the correlations between each pair of values in the sample. By considering the variance, the importance of each sample in the training process is weighted accordingly. During the M step, both the weights αₜ and the covariance matrix Pₜ are updated based on Hₜ, Pₜ, and Gₜ to maximize the alignment between the predicted and actual future values. The EM process iterates when new samples come in to refine the forecasting model.

### IV. Adaptive Hyperdimensional Forecasting System Overview

The inventive concepts described herein can provide a rigorous problem formulation for online IoT forecasting, encompassing typical noise types, model inputs, and outputs. The Adaptive Hyperdimensional Forecasting System can integrate HDC techniques with KF methodologies to enhance robustness against sensor noise, while also addressing energy constraints through the use of binary operations.

### A. Problem Definition

IoT scenarios can often involve a substantial number of inexpensive sensors operating at low sampling frequencies. As a result, datasets can be characterized by multiple time series, each containing a subset of relatively noisy samples, leading to highly noisy data. Building on this observation, the Adaptive Hyperdimensional Forecasting System can address three major types of noise: Gaussian noise, missing values, and Poisson noise.

Normal Gaussian noise, represents the standard errors that may arise from sensor disturbances. To simulate this, random values are added from a Gaussian curve with a mean of 0 and standard deviations of 0.1, 0.2, 0.5, 1.

Missing values, occur when the sensors' power supply fails or there's a low sampling rate. To model this, the time series is partitioned into segments of s samples, each having a certain probability of being missing. If a segment is missing, all of its values are replaced with 0.

Poisson Noise, representative of shot noise or disturbances arising from electrical charges in IoT sensor data, which results in irregular fluctuations in the data. To simulate this, random values are added according to the Poisson distribution with λ of 0.1, 0.2, 0.4, 0.5.

In the forecasting problem addressed by the Adaptive Hyperdimensional Forecasting System, the input X_{t:t+p}∈ [symbol] ^{p} can include p consecutive samples from timestamp t. The output is a single-step forecasting y̅=Xₜ₊ₚ₊₁∈ [symbol] , that minimizes the discrepancy with the actual future value y=Xₜ₊ₚ₊₁∈ [symbol] . Training is done in a single pass, and the model is updated with each new incoming sample. This online setting aligns well with the real-time nature of IoT and the resource constraints imposed by edge computing environments.

### B. Adaptive Hyperdimensional Forecasting System

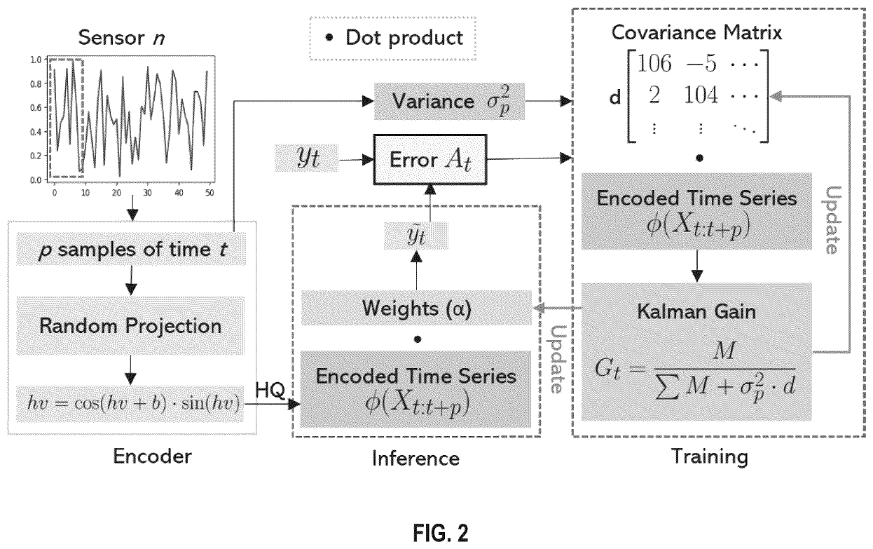

The Adaptive Hyperdimensional Forecasting System can be a novel, lightweight, and robust approach for training single-step forecasting models on sensor devices. The system can implement a method that is structured into three main phases: encoding, inference, and training, as illustrated in FIG. 2.

FIG. 2 illustrates the framework of an example Adaptive Hyperdimensional Forecasting System, including encoding, inference, and training phases, for on-device time series forecasting. In the encoding phase, the past p values X_{t:t+p} from all sensors into a single hypervector φ(X_{t:t+p}). The Adaptive Hyperdimensional Forecasting System can adopt steps based on the KF to estimate the weights, denoted as αₜ∈ [symbol] ^{d}, by which the encoded past values are multiplied. This process allows the hypervector to be transformed back to the original space, thereby generating the final prediction \tilde{y}ₜ=\tilde{X}ₜ₊ₚ₊₁ during inference. To estimate αₜ from noisy observations, the method can iteratively update Kalman Gain Gₜ and covariance matrix Pₜ using incoming samples and prediction errors, thereby merging the noise resilience properties of the KF with the computational efficiency of HDC

In contrast to RegHD, the Adaptive Hyperdimensional Forecasting System can enhance the robustness of the forecasting model by incorporating the variance into its computations. Compared to a traditional KF, the Adaptive Hyperdimensional Forecasting System can leverage the expressive power and robustness of HDC, thereby further improving resilience to noise.

The details of each phase of the Adaptive Hyperdimensional Forecasting System can be described as follows:

(a) Encoding. Given the time series readings from multiple sensors, the encoding step in the Adaptive Hyperdimensional Forecasting System can map the time series from one sensor, X_{t:t+p}, into a single hypervector, φ(X_{t:t+p}), using the nonlinear encoding methodThe Adaptive Hyperdimensional Forecasting System can encode the time series from different sensors separately while training a global model, represented by the weight hypervector αₜ, for forecasting.

(b) Inference. The inference phase predicts the next-step reading \tilde{y}ₜ based on the past p values of a specific sensor n. In the Adaptive Hyperdimensional Forecasting System, this can be achieved by multiplying the encoded hypervector φ(X_{t:t+p}) by the global model a, using the dot product, i.e., ŷₜ=φ(X_{t:t+p})·αₜ.

(c) Training. The training phase can iteratively update the weight vector αₜ∈ [symbol] ^{d} and the covariance matrix Pₜ. The covariance matrix Pₜ can capture the uncertainty or variance in the estimates of the weights and can represent the correlations between each pair of values in the sample X_{t:t+p}. When starting the model, α₀ can be initialized as zeros while P₀ is filled with ones.

For each incoming sample, the Kalman Gain Gₜ can be computed in a manner similar to a conventional KF, e.g., similar to f(Hₜ, Pₜ, σ²), with a difference being that Hₜ is replaced by the encoded input samples φ(X_{t:t+p}). As a result, the numerator results in a d-vector, similar to the process in a traditional KF. However, a major distinction lies in the calculation of HₜPₜHₜ^{T}, which is substituted by ΣPₜφ(X_{t:t+p}). To further enhance the efficiency of the Adaptive Hyperdimensional Forecasting System, the matrix multiplication can be quantized, a process referred to as HQ. This quantization can improve computational efficiency. When computing Gₜ, the variance

$${σ}_{p}^{2}$$

can be scaled to ensure no significance is maintained. The variance

$${σ}_{p}^{2}$$

can manage the importance and impact of individual samples in the training process and contribute to the overall robustness of the method.

Then, both αₜ and Pₜ can be updated. The model weights αₜ can be updated similarly to the process in a KF, (αₜ=αₜ+GₜAₜ), but with the inclusion of a learning rate η to accommodate the high dimensionality of the samples. The covariance matrix Pₜ can be updated by multiplying M with the transposed input sample, resulting in a matrix that represents the relationship between each pair of dimensions.

The complete process can be summarized as follows:

$$M = HQ ( P \cdot {ϕ ( {X}_{t : t + p} )}^{T} ) \qquad ( 4 )$$

$${G}_{t} = \frac{M}{\sum M + {σ}_{p}^{2} \cdot d} \qquad ( 5 )$$

$${α}_{t} = {α}_{t} + {G}_{t} {A}_{t} η \qquad ( 6 )$$

$${P}_{t} = {P}_{t} + HQ ( {G}_{t} ) ⊗ {M}^{T} \qquad ( 7 )$$

Given that the variance may not be known beforehand, the variance of the time

$${σ}_{p}^{2}$$

of the time series can be inferred based on the previous and/or current samples. To address this issue, the variance can be stored and updated with each new sample according to the formula:

$${σ}_{p}^{2} = ( γ \cdot {σ}_{p}^{2} ) + ( 1 - γ ) \cdot {σ}^{2} ( x ) .$$

Here, γ represents a coefficient that determines the balance between the importance of the past variance and the new variance from the incoming samples.

### C. The Efficiency of the Adaptive Hyperdimensional Forecasting System

In the initial stages of the Adaptive Hyperdimensional Forecasting System, the training process could closely follow the KF methodology. However, this approach involved three significant matrix multiplications: two for Gₜ (in both the numerator and denominator) and another for updating Pₜ in FIG. 1, which posed computational challenges due to the large size of the matrix (d×d).

To address this issue, the binary representation of M in Equation (4) can be utilized. Binarizing matrix multiplication simplifies runtime operations at the cost of some accuracy (due to the loss of precision in numbers), especially with a constant dimensionality d. Additionally, updates to Pₜ can be streamlined with binary operations, significantly reducing computational complexity. Specifically, the multiplication can now be reduced to XOR operations (⊗). The updated covariance matrix Pₜ can now store integers, as its updated values are in the range of {−1,1}. This optimization can substantially improve the efficiency of the training process of the Adaptive Hyperdimensional Forecasting System. To further enhance the efficiency, the model can be trained only when the error Aₜ exceeds a predefined threshold (in this scenario Aₜ>0.1).

### V. Evaluation

### A. Experimental Setup

Datasets: The datasets utilized can represent typical Internet of Things (IoT) data, comprising multiple time series collected from various sensors with limited samples. These datasets can encompass two primary categories: energy consumption and traffic forecasting, each featuring different time resolutions. Such datasets can be chosen to reflect the resource constraints typical of data-collecting devices, emphasizing the importance of timely forecasting. Table I illustrates an example summary of the dataset characteristics used in evaluating the disclosed Adaptive Hyperdimensional Forecasting System, including the number of sensors, frequency, and sample count. The samples can be partitioned in a linear manner, allocating 70% for training, 20% for testing, and 10% for cross-validation. The input samples can be selected using a sliding window approach with a step size of 1, utilizing a time window length of p=20. This sliding window technique can involve using the initial p values of the time series as the initial training input and subsequently shifting the training window forward by one step to obtain successive training inputs.

TABLE I

| | | | Time | Time Series |
|---|---|---|---|---|
| Dataset | Type | Frequency | Series | Samples |
| ECF | Energy | Daily | 314 | 365 |
| SFT | Traffic | Weekly | 862 | 104 |
| MITV | Traffic | Hourly | 1 | 33728 |
| GT | Traffic | Hourly | 206 | 1464 |
| ELD | Energy | Daily | 320 | 1096 |

Implementation Details: The Adaptive Hyperdimensional Forecasting System can be implemented using Python 3.9 with PyTorch and TorchHD libraries. The hyperparameters described in the design can be selected through validation tests to balance model accuracy and efficiency, including considerations for the non-linear encoder. Table II illustrates an example set of hyperparameters used in the disclosed Adaptive Hyperdimensional Forecasting System, detailing parameters such as learning rate and dimensionality used in experiments.

TABLE II

| Dataset | η | d | γ | p |
|---|---|---|---|---|
| Energy Consumption | 0.001 | 500 | 0.03 | 20 |
| Fraunhofer (ECF) | | | | |
| San Francisco | 0.001 | | | |
| Traffic (SFT) | | | | |
| Metro Interstate | 0.00001 | | | |
| Traffic Volume (MITV) | | | | |
| Guangzhao Traffic (GT) | 0.001 | | | |
| Electricity Load | 0.0001 | | | |
| Diagrams (ELD) | | | | |

The models compared are:

E-Sense: E-Sense can combine multiple layers of Convolutional Neural Networks (CNN) and a parallel Long Short-Term Memory (LSTM) model to address various types of noise, primarily Gaussian noise. An open-source implementation of this model can be utilized for adaptation in certain embodiments.

PFVAE: PFVAE can employ a Long Short-Term Memory (LSTM) network as an auto-encoder along with a variational auto-encoder (VAE) for time series prediction to mitigate the effects of Gaussian noise. Since the code for PFVAE may not be publicly available, a manual implementation can be utilized without incorporating the planar flow section.

RegHD: RegHD can be an HDC-based regression method suitable for handling IoT data affected by hardware noise. An open-source implementation of RegHD can be adapted, utilizing a default learning rate of 1×10⁻⁶.

The evaluation of each test sample can use the mean absolute error (MAE) between the predicted and actual values. For efficiency experiments, two representative edge devices can be utilized, including a Raspberry Pi 4B with 4 GB RAM and an edge desktop with an Intel Core i7-8700 CPU at 3.2 GHz and 16 GB RAM. The execution time can be measured on these devices, which can linearly reflect the amount of energy consumed during the performance of various methods.

### B. MAE/Robustness Results

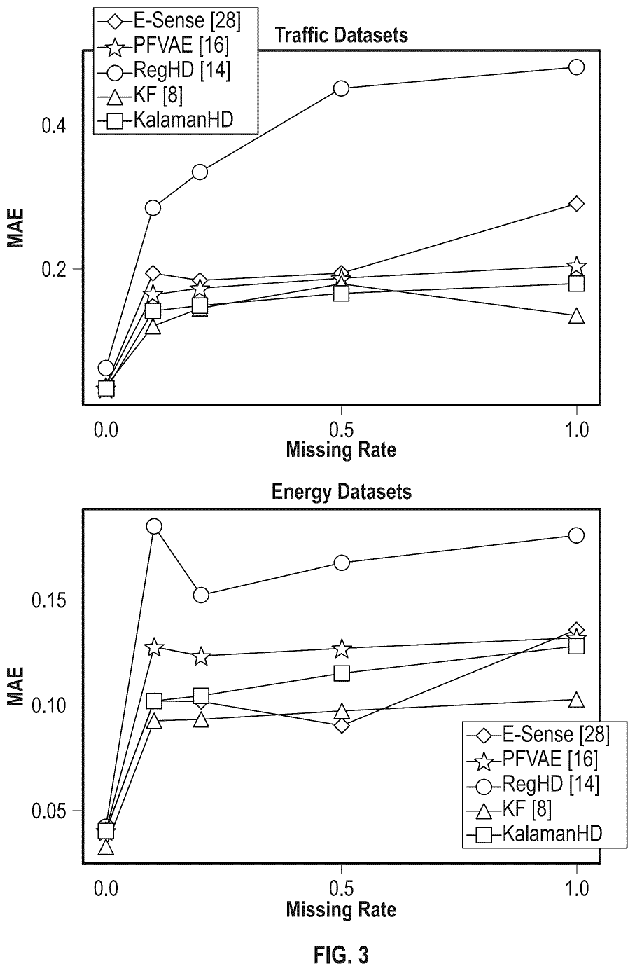

FIG. 3 presents two plots illustrating the average mean absolute error (MAE) for different methods when applied to datasets with various rates of missing samples. The left plot depicts the results for traffic datasets, while the right plot shows the outcomes for energy datasets. Each curve corresponds to a different forecasting method, including E-Sense, PFVAE, RegHD, the KF, and the Adaptive Hyperdimensional Forecasting System (sometimes referred to as KalmanHD). The MAE values are plotted against the missing rate on the x-axis, indicating how performance degrades as the amount of missing data increases. A lower MAE indicates a more accurate forecast, and the plots demonstrate that the Adaptive Hyperdimensional Forecasting System maintains a lower MAE compared to RegHD, highlighting its robustness against missing data.

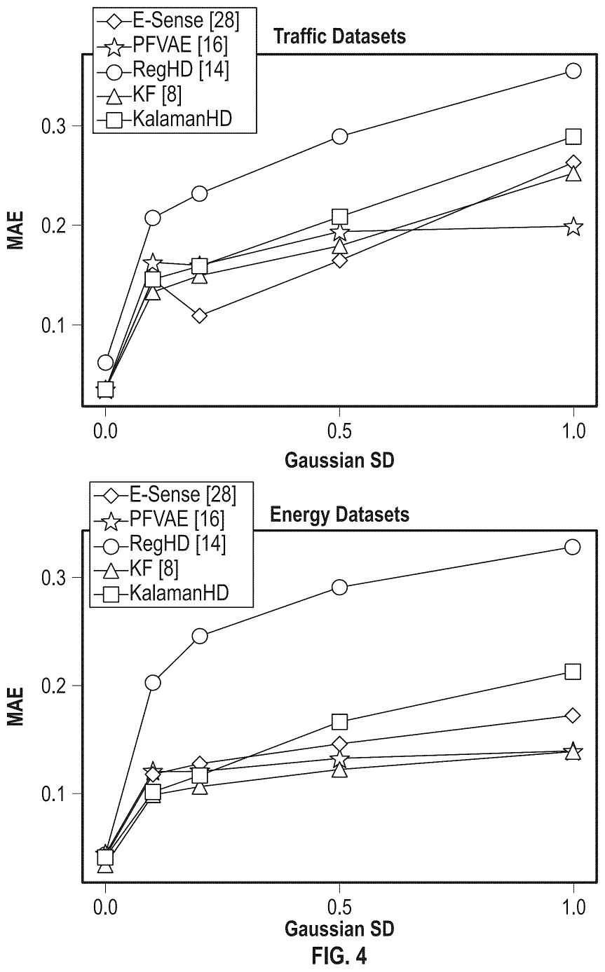

FIG. 4 presents two plots illustrating the average MAE for all forecasting methods under varying levels of Gaussian noise. The left plot represents the traffic datasets, while the right plot represents the energy datasets. The MAE is plotted against different values of Gaussian standard deviation (SD), reflecting how each method responds to increasing noise levels. The methods being compared include E-Sense, PFVAE, RegHD, the KF, and the Adaptive Hyperdimensional Forecasting System. The plots show that the Adaptive Hyperdimensional Forecasting System exhibits superior performance, with lower MAE values compared to other methods, indicating its improved resilience to Gaussian noise.

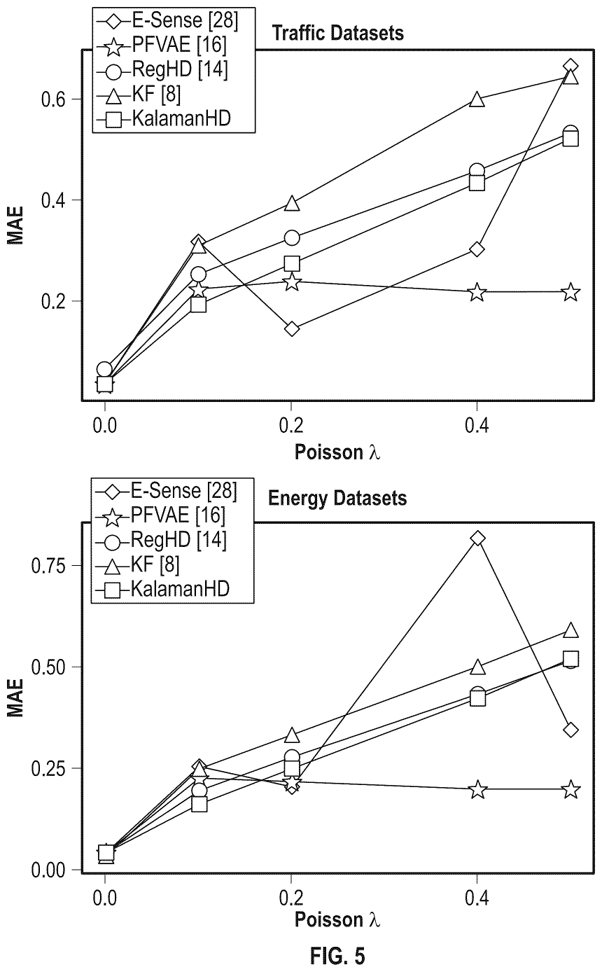

FIG. 5 presents two plots that show the average MAE of the different forecasting methods under varying levels of Poisson noise, indicated by the parameter λ. The left plot focuses on the traffic datasets, and the right plot focuses on the energy datasets. Each curve corresponds to one of the evaluated methods: E-Sense, PFVAE, RegHD, the KF, and the Adaptive Hyperdimensional Forecasting System. The x-axis indicates the level of Poisson noise (λ), and the y-axis represents the MAE. The plots indicate that the Adaptive Hyperdimensional Forecasting System can maintain a lower MAE compared to RegHD and the KF under increasing noise, demonstrating its enhanced noise resilience in both types of datasets.

RegHD can experience considerable performance deterioration when confronted with sensor noise, as RegHD may not be designed to withstand sensor noise effectively, despite the inherent resilience of HDC to hardware errors due to its high dimensionality. The raw KF can exhibit strong performance under Gaussian noise and missing samples, consistent with its Gaussian noise assumption; however, it can underperform significantly when subjected to other types of noise, such as Poisson noise. The Adaptive Hyperdimensional Forecasting System can demonstrate robustness across different noise conditions, including Gaussian noise, Poisson noise, and missing values, utilizing the integration of HDC and KF. Under extreme noise conditions, the Adaptive Hyperdimensional Forecasting System can outperform RegHD, improving MAE performance by up to 72%.

### C. Efficiency Results

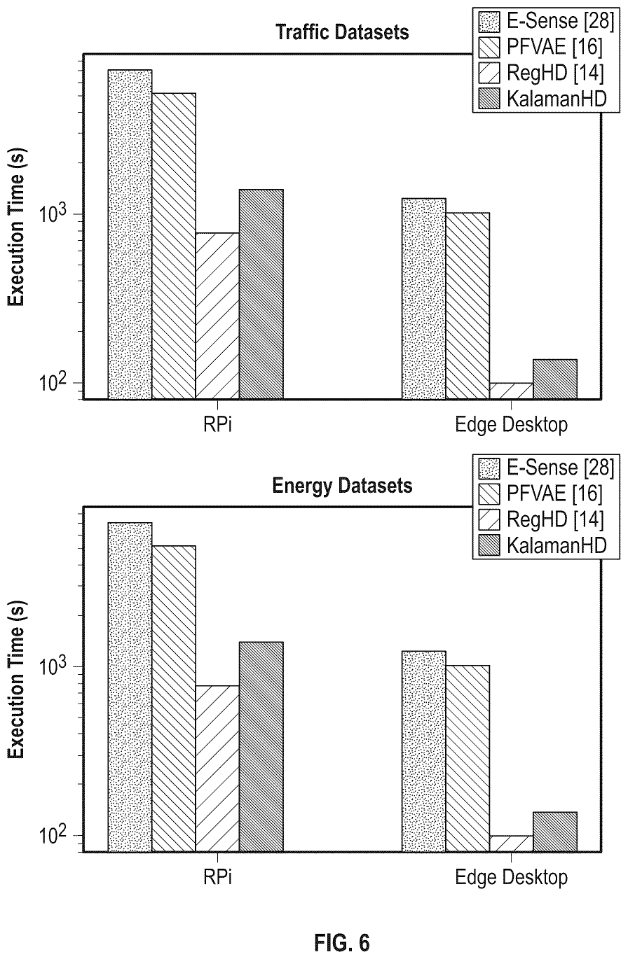

FIG. 6 presents two bar charts illustrating the average execution times, in seconds, of each baseline model and the Adaptive Hyperdimensional Forecasting System for completing a single pass on traffic and energy datasets. The left chart depicts the execution times on the Raspberry Pi (RPi) and edge desktop for traffic datasets, while the right chart depicts similar results for energy datasets. Each bar represents a specific method, including E-Sense, PFVAE, RegHD, and the Adaptive Hyperdimensional Forecasting System (sometimes referred to as KalmanHD).

The y-axis represents the execution time on a logarithmic scale, indicating the computational efficiency of each method in both hardware environments. As depicted, the Adaptive Hyperdimensional Forecasting System achieves significantly lower execution times compared to E-Sense and PFVAE, particularly in the edge desktop environment. On the Raspberry Pi, the Adaptive Hyperdimensional Forecasting System can complete its computations faster by a factor of 5.0 compared to E-Sense and by a factor of 3.6 compared to PFVAE. On the edge desktop, it demonstrates even more efficiency, with execution times 8.6 times and 7.1 times faster than E-Sense and PFVAE, respectively.

While RegHD demonstrates the lowest computational time, it lacks robustness in the presence of noise, resulting in significant forecasting errors, thereby limiting its applicability for noisy IoT environments. The Adaptive Hyperdimensional Forecasting System, on the other hand, can incorporate sophisticated computations inspired by the KF, adding only up to 48% additional computational time compared to RegHD when executed on the edge desktop, but with considerably improved resilience to noise.

For all datasets, the Adaptive Hyperdimensional Forecasting System can complete one pass of the entire dataset in under 35 minutes on a Raspberry Pi and less than 4 minutes on an edge desktop. These findings highlight the efficiency and practical suitability of the Adaptive Hyperdimensional Forecasting System for edge computing scenarios, providing a balance of fast execution times, resource optimization, and robust forecasting in noisy environments.

In Internet of Things (IoT) forecasting, at least two primary challenges can arise: limited energy resources necessitating the development of efficient computational models, and noise introduced by sensors as a result of resource constraints. HDC can be a promising approach that focuses on efficient computing while providing hardware noise resistance; however, it may lack robustness against sensor noise. The Adaptive Hyperdimensional Forecasting System can address these challenges by integrating HDC with the KF, thereby improving the model's resilience to sensor noise while maintaining efficiency.

Through extensive experimentation on real IoT datasets containing varying levels of Gaussian noise, missing samples, and Poisson noise, the Adaptive Hyperdimensional Forecasting System can demonstrate accuracy results that are comparable to those of robust deep networks in online forecasting scenarios. Additionally, the system can exhibit substantial speed improvements, achieving speedups of 3.6 to 8.6 times compared to traditional deep networks on typical edge computing platforms. This combination of computational efficiency, robustness, and speed highlights the potential of the Adaptive Hyperdimensional Forecasting System for real-time IoT applications where energy efficiency and noise resilience are important.

### Adaptive Hyperdimensional Forecasting System for Edge Devices

Forecasting time series data in edge computing environments can be beneficial for Internet of Things (IoT) applications, allowing devices to make timely data-driven decisions. Traditional forecasting methods, such as statistical models or neural networks, can face limitations when applied to edge devices, which can have restricted processing power and need to handle noisy data. These conditions can indicate a need for a forecasting system that adapts to resource constraints while effectively managing real-time demands. Conventionally, complex time series forecasting models can require high processing power and rely on cloud-based systems, leading to continuous data transmission to central processing, which can increase energy consumption and latency.

Some inventive concepts described herein can relate to implementing an Adaptive Hyperdimensional Forecasting System on edge devices. The Adaptive Hyperdimensional Forecasting System can process data collected from multiple sensors while handling common sensor noise types, such as Gaussian noise, missing values, and Poisson noise. The Adaptive Hyperdimensional Forecasting System can integrate Hyperdimensional Computing (HDC) techniques with Kalman Filters (KF) to enable predictions that can be resilient to sensor noise. This system can support single-pass processing, which can be beneficial for edge devices that prioritize real-time forecasting capabilities. For instance, time series data can be encoded into high-dimensional vectors, and forecasting weights updated iteratively to improve prediction accuracy in dynamic environments.

Practical applications of the Adaptive Hyperdimensional Forecasting System can include IoT scenarios where localized analysis is useful, such as in smart cities, industrial monitoring, and autonomous systems. For example, an edge device in a manufacturing environment can monitor equipment and predict maintenance needs without frequent communication with a cloud server. Such localized forecasting can reduce network dependence, potentially lowering energy consumption and bandwidth by decreasing the frequency of data transmissions to external servers.

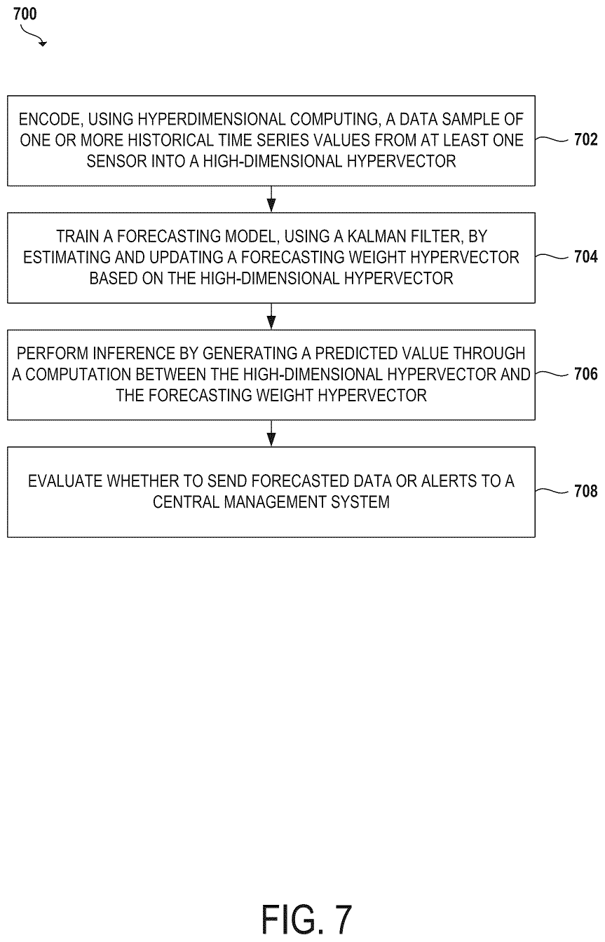

FIG. 7 presents a flow diagram illustrating an embodiment of an on-device time series forecasting routine 700 that can be implemented by the Adaptive Hyperdimensional Forecasting System on edge devices. The diagram can outline processes for encoding sensor data, training forecasting models using HDC-enhanced KF, and performing inference to generate predictions. Though the method described can include edge devices, elements of routine 700 can also interface with cloud systems for periodic updates or model refinements. Therefore, this embodiment should not be seen as limiting.

At block 702, the Adaptive Hyperdimensional Forecasting System can perform encoding, using Hyperdimensional Computing, of a data sample of one or more historical time series values from at least one sensor into a high-dimensional hypervector. The encoding can include applying a transformation to generate the high-dimensional hypervector. This encoding process can transform sensor data into a format that is more tolerant of noise in edge environments. Each sensor's data can be encoded individually, with hypervectors representing time series data from distinct sensors combined into a unified vector format. This encoded data format can allow for efficient single-pass processing, a design that can help minimize computational demands on the device.

As described herein, the encoding process can utilize transformations that map raw sensor values into a high-dimensional space, preserving data characteristics while reducing sensitivity to noise. This encoding method can enable the Adaptive Hyperdimensional Forecasting System to manage challenges associated with dynamic, real-world data. By encoding and storing this data locally, the Adaptive Hyperdimensional Forecasting System can achieve robust processing without requiring iterative re-encoding, supporting streamlined operations that may suit resource-constrained environments.

At block 704, the Adaptive Hyperdimensional Forecasting System can perform training of a forecasting model, using a Kalman Filter, by estimating and updating a forecasting weight hypervector based on the high-dimensional hypervector. The Kalman Filter can process each high-dimensional hypervector to update the forecasting weight hypervector, and employ binary operations for updating a covariance representation and calculating a Kalman Gain. The Kalman Filter can iteratively adjust the weight hypervector to reduce prediction errors, improving the forecasting model's accuracy. This adjustment can be based on observed discrepancies between predicted and actual values, allowing the model to dynamically optimize in response to real-time data. The training process in the Adaptive Hyperdimensional Forecasting System can employ binary operations for covariance updates, which can reduce computational load and support efficient processing. This adaptation can help ensure the model remains functional on edge devices.

In some cases, the Kalman Filter can perform updates with reduced overhead by approximating conventional matrix multiplications through binary operations. This method can reduce the complexity of covariance calculations, conserving device resources. This design can be advantageous for edge devices that may lack the computational power for traditional matrix operations. Such updates can also help maintain the forecasting model's robustness, adapting to data fluctuations while minimizing computational strain.

At block 706, the Adaptive Hyperdimensional Forecasting System can perform inference by generating a predicted value through a computation between the high-dimensional hypervector and the forecasting weight hypervector. This inference step can involve using the trained weight vector to compute the predicted value for the next time step in the data series. During inference, the Adaptive Hyperdimensional Forecasting System can complete predictions in a single pass, allowing real-time forecasts without revisiting prior data. This design can suit applications that require continuous predictions, as it reduces delays associated with multi-pass inference models.

In some embodiments, the Adaptive Hyperdimensional Forecasting System can adjust the forecasting weight hypervector when prediction errors exceed a predefined threshold. This selective updating approach can improve model efficiency by recalibrating only when significant deviations from expected values occur, potentially preserving resources. By monitoring prediction accuracy and adjusting only as needed, the system can reduce unnecessary processing, supporting efficient, on-device operation that conserves memory and power.

In some cases, the Adaptive Hyperdimensional Forecasting System can adapt to noise in the data by updating the model in response to changes in data variance. For instance, as variance in incoming sensor data increases, the Kalman Filter can adjust the forecasting weight hypervector accordingly, allowing the model to manage data disruptions effectively. This adaptive response to variance can help the Adaptive Hyperdimensional Forecasting System maintain accuracy across varying environmental conditions.

In certain implementations, the Adaptive Hyperdimensional Forecasting System can further enhance model robustness by calculating covariance values within the hyperdimensional space, leveraging Hyperdimensional Computing's inherent noise resilience. This approach can reduce the forecasting model's sensitivity to noisy data, allowing it to perform more accurately even in high-noise scenarios. In some cases, a unified forecasting weight hypervector can manage data from multiple sensors, simplifying model complexity and helping to ensure cohesive forecasts across different data inputs.

At block 708, the edge device can evaluate whether to send forecasted data or alerts to a central management system. This decision can depend on predefined thresholds or specific conditions, such as detecting anomalies. For instance, when the Adaptive Hyperdimensional Forecasting System detects an unusual trend in sensor data indicating potential failure, the device can generate an alert and transmit it to the cloud for further analysis. This selective communication approach can help reduce bandwidth usage and conserve energy by limiting data transmission to only critical information.

In some scenarios, the Adaptive Hyperdimensional Forecasting System can store forecast data locally for trend analysis or reporting. For instance, an edge device can maintain a historical record of predictions and actual values, which can support offline analysis of model performance. Maintaining this local record can provide the device with an additional resource for validation, allowing future model adjustments without frequent server communication.

It can be understood that fewer, more, or different blocks can be included in routine 700 as illustrated in FIG. 7. For instance, if the Adaptive Hyperdimensional Forecasting System detects substantial noise increases that may compromise forecast reliability, it can temporarily pause updates or apply alternative estimation techniques. Such adjustments can help ensure that the Adaptive Hyperdimensional Forecasting System operates reliably across various IoT applications and remains efficient in environments with diverse and changing data characteristics.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this Section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this Section or elsewhere in this specification, and may be defined by claims as presented in this Section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for on-device time series forecasting using Hyperdimensional Computing and a Kalman Filter, comprising:
encoding, using Hyperdimensional Computing, a data sample of one or more historical time series values from at least one sensor into a high-dimensional hypervector, wherein the encoding comprises applying a transformation to generate the high-dimensional hypervector;
training a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
performing inference by generating a predicted value through a computation between the high-dimensional hypervector and the forecasting weight hypervector,
wherein the encoding and inference operations are performed in a single pass for the data sample.

2. The method of claim 1, wherein each data sample is processed only once during the training and inference operations, without requiring multiple epochs, iterative revisits, or reprocessing.

3. The method of claim 1, further comprising outputting an indication of the predicted value, wherein the predicted value is a forecasted future value of the time series data.

4. The method of claim 1, wherein the Kalman Filter employs no matrix multiplications for updating the covariance representation and calculating the Kalman Gain.

5. The method of claim 1, wherein the Kalman Filter employs only binary operations for updating the covariance representation and calculating the Kalman Gain.

6. The method of claim 1, wherein updating the forecasting weight hypervector further comprises updating the covariance matrix using the Kalman Gain, wherein the Kalman Gain is computed based on the high-dimensional hypervector and applied to adjust the covariance matrix.

7. The method of claim 1, wherein encoding comprises transforming the historical time series values into the high-dimensional hypervector using a random projection followed by a non-linear transformation.

8. The method of claim 1, wherein encoding comprises processing time series data from multiple sensors, with sensor data from each sensor being encoded separately, and wherein a unified forecasting weight hypervector is used to generate the predictions.

9. The method of claim 1, wherein training the forecasting weight hypervector comprises iteratively adjusting the forecasting weight hypervector using discrepancies between predicted values and actual values, and wherein estimating the forecasting weight hypervector comprises calculating a Kalman Gain based on a covariance matrix and received data sample.

10. The method of claim 6, wherein the covariance matrix is calculated in a hyperdimensional space.

11. The method of claim 1, further comprising updating the forecasting weight hypervector based on a determination that a prediction error satisfies a predefined threshold.

12. The method of claim 1, wherein the Kalman Filter estimates a forecasting weight hypervector for each of multiple sensors, wherein each high-dimensional hypervector corresponds to historical data received from a respective sensor.

13. The method of claim 1, further comprising determining a variance of the received data samples, wherein the variance is used by the Kalman Filter to adjust the iterative updating of the forecasting weight hypervector.

14. The method of claim 1, further comprising determining a variance for the received data sample, wherein the variance is calculated based on previous and current data samples, and is iteratively updated as each new data sample is received.

15. An edge device for on-device time series forecasting, comprising:
a processor configured to:
encode, using Hyperdimensional Computing, a data sample of one or more historical time series values from at least one sensor into a high-dimensional hypervector, wherein the encoding comprises applying a transformation to generate the high-dimensional hypervector;
train a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
perform inference by generating a predicted value through a computation between the high-dimensional hypervector and the forecasting weight hypervector,
wherein the encoding and inference operations are performed in a single pass for the data sample.

16. The device of claim 17, further comprising the at least one sensor configured to collect the time series data, and a memory configured to store the forecasting weight hypervector, the high-dimensional hypervector, and intermediate results for encoding, training, and inference.

17. A non-transitory computer-readable medium storing instructions that, when executed by a processor, cause the processor to perform a method for on-device time series forecasting using Hyperdimensional Computing (HDC) and a Kalman Filter, the method comprising:
encoding, using Hyperdimensional Computing, a data sample of one or more historical time series values from at least one sensor into a high-dimensional hypervector, wherein the encoding comprises applying a transformation to generate the high-dimensional hypervector;
training a forecasting model, using a Kalman Filter, by estimating and updating a forecasting weight hypervector based on the high-dimensional hypervector, wherein the Kalman Filter processes each high-dimensional hypervector to update the forecasting weight hypervector, and employs binary operations for updating a covariance representation and calculating a Kalman Gain; and
performing inference by generating a predicted value through a computation between the high-dimensional hypervector and the forecasting weight hypervector,
wherein the encoding and inference operations are performed in a single pass for the data sample.

18. The non-transitory computer-readable medium of claim 17, wherein each data sample is processed only once during the training and inference operations, without requiring multiple epochs, iterative revisits, or reprocessing.

19. The non-transitory computer-readable medium of claim 17, wherein the Kalman Filter employs only binary operations for updating the covariance representation and calculating the Kalman Gain.

20. The non-transitory computer-readable medium of claim 17, wherein the Kalman Filter employs no matrix multiplications for updating the covariance representation and calculating the Kalman Gain.
